(19) United States
(12) Patent Application Publication
(10) Pub. No.: US 2026/0238056 A1
(43) Pub. Date: Aug. 13, 2026

(54) MOTOR UNIT

(71) Applicant: TOYOTA JIDOSHA KABUSHIKI KAISHA, Toyota-shi (JP)

(72) Inventor: Yukinori TSURUMI, Toyota-shi (JP)

(73) Assignee: TOYOTA JIDOSHA KABUSHIKI KAISHA, Toyota-shi (JP)

(21) Appl. No.: 19/408,743

(22) Filed: Dec. 4, 2025

(30) Foreign Application Priority Data
Feb. 7, 2025 (JP) 2025-019490

(51) Int. Cl. H02K 1/32; H02K 1/16

(52) U.S. Cl. CPC H02K 1/32; H02K 1/16

(57) ABSTRACT

The motor unit includes a shaft that extends along an axial direction, a rotor that is fixed to an outer peripheral surface of the shaft, and a stator that is disposed on a radially outer side of the rotor. The shaft includes a first shaft flow path that extends in the axial direction in the shaft, and at least one second shaft flow path that branches from the first shaft flow path and extends to an opening of the outer peripheral surface of the shaft. The rotor includes at least one rotor flow path that extends from an opening of an inner peripheral surface of the rotor to an opening of an outer peripheral surface of the rotor and that supplies a refrigerant toward the stator. Each of the at least one rotor flow path communicates with any of the at least one second shaft flow path.

### CROSS-REFERENCE TO RELATED APPLICATION

This application claims priority to Japanese Patent Application No. 2025-019490 filed on February 7, 2025. The disclosure of the above-identified application, including the specification, drawings, and claims, is incorporated by reference herein in its entirety.

### BACKGROUND

### 1. Technical Field

A technique disclosed in the present specification relates to a motor unit.

### 2. Description of Related Art

Japanese Unexamined Patent Application Publication No. 2023-002070 (JP 2023-002070 A) discloses a motor unit including a shaft extending along an axial direction, a rotor that is fixed to an outer peripheral surface of the shaft, and a stator that is disposed on a radially outer side of the rotor.

### SUMMARY

The motor unit of JP 2023-002070 A further includes a cooling oil passage that is disposed on a radially outer side of the stator. The cooling oil passage includes a spray hole that is configured to spray oil toward a coil end of the stator. The coil end is cooled by the oil sprayed from the spray hole coming into contact with the coil end. In JP 2023-002070 A, there is no consideration of supplying the oil from a radially inner side of the stator to the stator.

The present specification provides a technique of supplying a refrigerant from a radially inner side of a stator to the stator.

According to a first aspect of the present technique, the motor unit may include

a shaft extending along an axial direction,

a rotor fixed to an outer peripheral surface of the shaft, and

a stator disposed on a radially outer side of the rotor.

The shaft may include a first shaft flow path extending in the axial direction in the shaft, and one or more second shaft flow paths branched from the first shaft flow path and extending to an opening of the outer peripheral surface of the shaft.

The rotor may include one or more rotor flow paths extending from an opening of an inner peripheral surface of the rotor to an opening of an outer peripheral surface of the rotor, and configured to supply a refrigerant toward the stator.

Each of the one or more rotor flow paths may be in communication with any one of the one or more second shaft flow paths.

With the above-described configuration, the refrigerant passing through the first shaft flow path, the second shaft flow path, and the rotor flow path is supplied to the stator. Therefore, the refrigerant can be supplied from the radially inner side of the stator to the stator.

According to a second aspect, in the first aspect, the one or more rotor flow paths may include a flow path configured to supply the refrigerant toward a central portion of the stator in the axial direction.

The central portion of the stator in the axial direction may easily generate heat. With the above-described configuration, the refrigerant is supplied from the rotor flow path toward the central portion of the stator. Therefore, the central portion of the stator can be cooled.

According to a third aspect, in the first or second aspect, the stator may include

a stator core having a plurality of slots, and

a stator coil including a plurality of segment coils and a plurality of connecting portions configured to connect end portions of two segment coils in the slots.

The one or more rotor flow paths may include a flow path configured to supply the refrigerant toward at least one of the connecting portions.

The connecting portions that connect the end portions of the two segment coils may easily generate heat. With the above-described configuration, the refrigerant is supplied from the rotor flow path toward the connecting portion. Therefore, the connecting portion can be cooled.

According to a fourth aspect, in any one of the first to third aspects, the one or more second shaft flow paths may include a plurality of second shaft flow paths.

The one or more rotor flow paths may include a plurality of rotor flow paths.

Each of the rotor flow paths may be in communication with any one of the second shaft flow paths.

With the above-described configuration, various parts of the stator can be cooled.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a drive device 2;

FIG. 2 is an end view of a shaft 40 and a rotor 42 as viewed from the other side of an axial direction;

FIG. 3 is a cross-sectional view of a stator 44 as viewed from one side of an axial direction;

FIG. 4 is a schematic diagram of a drive device 202;

FIG. 5 is a schematic diagram of a drive device 302; and

FIG. 6 is a schematic diagram of a drive device 402.

### DETAILED DESCRIPTION OF EMBODIMENTS

### First Embodiment

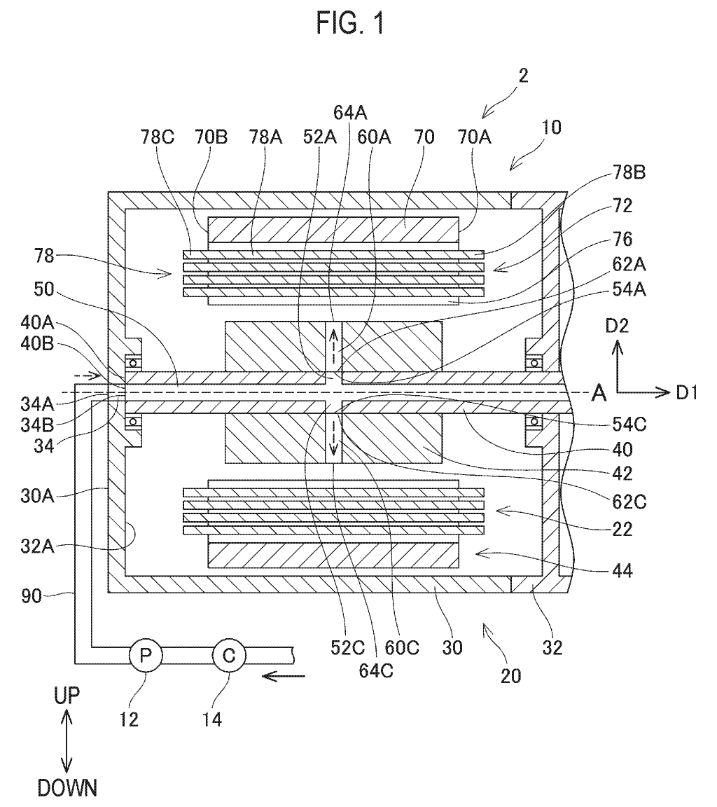

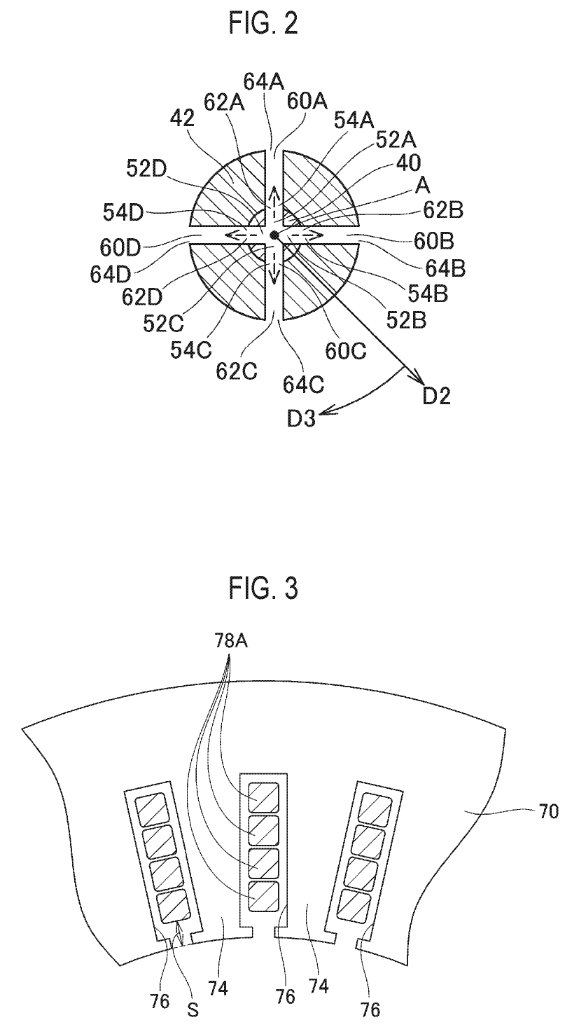

A drive device 2 will be described with reference to FIGS. 1 to 3. The drive device 2 is mounted in an electrified vehicle or the like. In the present specification, a cylindrical coordinate system consisting of an axial direction D1, a radial direction D2, and a circumferential direction D3 (see FIG. 2) is defined with the rotation axis A of a motor 22 as a reference. The axial direction D1 is a direction parallel to the rotation axis A of the motor 22, and the coordinate axis thereof is defined on the rotation axis. The radial direction D2 is a direction perpendicular to the axial direction D1 and is defined by a coordinate axis with the rotation axis A as an origin. The circumferential direction D3 of FIG. 2 is a direction perpendicular to the axial direction D1 and the radial direction D2 and is defined by a coordinate axis that revolves around the rotation axis A. In addition, an up-down direction in a state where the drive device 2 is mounted in the electrified vehicle substantially matches the up-down direction of FIG. 1. A left-right direction in a state where the drive device 2 is mounted in the electrified vehicle may be different from the left-right direction of FIG. 1. However, in the following, for ease of understanding, the description of the drawings may be made with reference to the left-right direction of FIG. 1.

As shown in FIG. 1, the drive device 2 includes a motor unit 10, a gear unit (not shown), an oil pump 12, and an oil cooler 14. The gear unit is provided on one side of the motor unit 10 in the axial direction D1. The one side of the axial direction D1 is a right side of FIG. 1. Hereinafter, the one side of the axial direction D1 will be referred to as “axial direction one side”.

The motor unit 10 includes a housing 20 and the motor 22. The housing 20 includes a first housing 30 and a second housing 32. The first housing 30 is open on the axial direction one side. The second housing 32 is connected to an end part of the first housing 30 on the axial direction one side. The first housing 30 includes a supply flow path 34. The supply flow path 34 extends between a first housing opening 34A located on an outer surface 30A of the first housing 30 and a second housing opening 34B located on an inner surface 30B of the first housing 30 in the axial direction D1.

The motor 22 is accommodated in the housing 20. The motor 22 includes the shaft 40, the rotor 42, and the stator 44. The shaft 40 extends along the rotation axis A. The rotation axis A is a rotation center of the shaft 40. The shaft 40 is rotatably supported by a bearing in the housing 20. The shaft 40 includes a first shaft flow path 50 and a plurality of second shaft flow paths 52A to 52D (see FIG. 2). The first shaft flow path 50 extends between a first shaft opening 40B located on a surface 40A of the shaft 40 on the axial direction D1 other side and a second shaft opening located on a surface of the shaft 40 on the axial direction one side in the axial direction D1. The first shaft flow path 50 is connected to the second housing opening 34B of the first housing 30. That is, the first shaft flow path 50 communicates with the supply flow path 34. As shown in FIG. 2, the plurality of second shaft flow paths 52A to 52D branch from the first shaft flow path 50. Each of the second shaft flow paths 52A to 52D extends from the first shaft flow path 50 to third shaft openings 54A to 54D located on an outer peripheral surface of the shaft 340 in the radial direction D2. The plurality of second shaft flow paths 52A to 52D are arranged at equal intervals in the circumferential direction D3.

As shown in FIG. 1, the rotor 42 is fixed to the shaft 40. The rotor 42 is an annular body that extends along the axial direction D1. The rotor 42 is configured by laminating a plurality of electromagnetic steel plates having the same shape in the axial direction D1. As shown in FIG. 2, the rotor 42 includes a plurality of rotor flow paths 60A to 60D. Each of the plurality of rotor flow paths 60A to 60D extends from first rotor openings 62A to 62D located on an inner peripheral surface of the rotor 42 to second rotor openings 64A to 64D located on an outer peripheral surface of the rotor 42 in the radial direction D2. The plurality of rotor flow paths 60A to 60D are arranged at equal intervals in the circumferential direction D3. Each of the rotor flow paths 60A to 60D communicates with the second shaft flow paths 52A to 52D. In the axial direction D1, positions of the flow flow path axes of the second shaft flow paths 52A to 52D and the rotor flow paths 60A to 60D are substantially the same as a position of a central portion of the stator 44 in the axial direction D1. Therefore, the oil discharged from the plurality of rotor flow paths 60A to 60D is supplied toward the central portion of the stator 44 in the axial direction D1.

As shown in FIG. 1, the stator 44 includes a stator core 70 and a stator coil 72. The stator core 70 is an annular body that extends along the axial direction D1. The stator core 70 is composed of a plurality of electromagnetic steel plates laminated in the axial direction D1. As shown in FIG. 3, a plurality of teeth portions 74 protrude from an inner periphery of the stator core 70 toward an inner side in the radial direction D2. The plurality of teeth portions 74 are arranged in the circumferential direction D3. Slots 76 are provided between the teeth portions 74 adjacent to each other in the circumferential direction. In the axial direction D1, the slots 76 penetrate the stator core 70. In the radial direction D2, the slots 76 extend from an inner peripheral surface of the stator core 70 to a middle of an outer peripheral surface of the stator core 70. The plurality of slots 76 are arranged in the circumferential direction D3.

As shown in FIG. 1, the stator coil 72 is attached to the stator core 70. The stator coil 72 includes a U-phase coil, a V-phase coil, and a W-phase coil. The stator coil 72 includes a plurality of coil wires 78. The plurality of coil wires 78 include a straight portion 78A that extends along the axial direction D1, a first coil end 78B, and a second coil end 78C. The first coil end 78B protrudes from a first end surface 70A of the stator core 70 on the axial direction one side to the axial direction one side. The second coil end 78C protrudes from a second end surface 70B of the stator core 70 on the axial direction other side to the axial direction other side. The straight portion 78A is disposed in the slots 76 of the stator core 70. The straight portion 78A extends along the axial direction D1. The straight portion 78A connects the first coil end 78B and the second coil end 78C. The straight portion 78A and the stator core 70 are insulated from each other. The position of the straight portion 78A in the slots 76 is fixed with a certain degree of strength. As shown in FIG. 3, in the radial direction D2, the straight portion 78A located on the innermost side is located on an outer side of an inner peripheral end of the slots 76. Therefore, a gap S is provided between the straight portion 78A and the inner peripheral end of the slots 76.

As shown in FIG. 1, an external flow flow path 90 is connected to the first housing opening 34A of the first housing 30. The oil pump 12 and the oil cooler 14 are provided in the external flow flow path 90. The external flow flow path 90 communicates with the first housing opening 34A and an oil reservoir (not shown).

The flow of the oil flowing through the drive device 2 will be described. Broken line arrows in FIGS. 1 and 2 indicate the flow of the oil.

The oil in the oil reservoir is sucked into the external flow flow path 90 by driving the oil pump 12. The oil sucked into the external flow flow path 90 is cooled by passing through the oil cooler 14. The oil cooled by the oil cooler 14 is supplied to the first shaft flow path 50 of the shaft 40 through the supply flow path 34 of the first housing 30. A part of the oil supplied to the first shaft flow path 50 is supplied to the rotor 42 through the plurality of second shaft flow paths 52A to 52D. In addition, the remaining oil supplied to the first shaft flow path 50 is supplied to the gear unit or the like.

The oil supplied to the rotor 42 is supplied toward the stator 44 from the plurality of rotor flow paths 60A to 60D. The oil is supplied toward the central portion of the stator 44 in the axial direction D1. As a result, the stator 44 is cooled.

The oil supplied toward the stator 44 flows into the oil reservoir through a gap S or the like between the rotor 42 and the stator 44 in the radial direction D2.

In the present embodiment, the oil cooled by the oil cooler 14 is supplied to the motor unit 10 before the gear unit or the like. That is, in the flow passage of the oil, the motor unit 10 is disposed on the upstream side of the gear unit or the like. With such a configuration, the motor unit 10 can be cooled more than in a configuration in which the motor unit 10 is disposed on the downstream side of the gear unit or the like.

As described above, the motor unit 10 includes the shaft 40 that extends along the axial direction D1, the rotor 42 that is fixed to the outer peripheral surface of the shaft 40, and the stator 44 that is disposed on the radially outer side of the rotor 42 in the radial direction D2. The shaft 40 includes the first shaft flow path 50 that extends in the axial direction D1 in the shaft 40, and the plurality of second shaft flow paths 52A to 52D that branch from the first shaft flow path 50 and extend from the third shaft openings 54A to 54D of the outer peripheral surface of the shaft 40. The rotor 42 includes the plurality of rotor flow paths 60A to 60D that extend from the first rotor openings 62A to 62D of the inner peripheral surface of the rotor 42 to the second rotor openings 64A to 64D of the outer peripheral surface of the rotor 42 and that supply oil (an example of a “refrigerant”) toward the stator 44. Each of the rotor flow paths 60A to 60D communicates with the second shaft flow paths 52A to 52D.

With the above-described configuration, the oil passing through the first shaft flow path 50, the second shaft flow paths 52A to 52D, and the rotor flow paths 60A to 60D is supplied to the stator 44. Therefore, the oil can be supplied from the radially inner side of the stator 44 in the radial direction D2 to the stator 44.

In addition, with the above-described configuration, various parts of the stator 44 can be cooled.

In addition, the plurality of rotor flow paths 60A to 60D supply the oil toward the central portion of the stator 44 in the axial direction D1.

The central portion of the stator 44 in the axial direction D1 may easily generate heat. With the above-described configuration, the oil is supplied from the rotor flow paths 60A to 60D toward the central portion of the stator 44. Therefore, the central portion of the stator 44 can be cooled.

### Second Embodiment

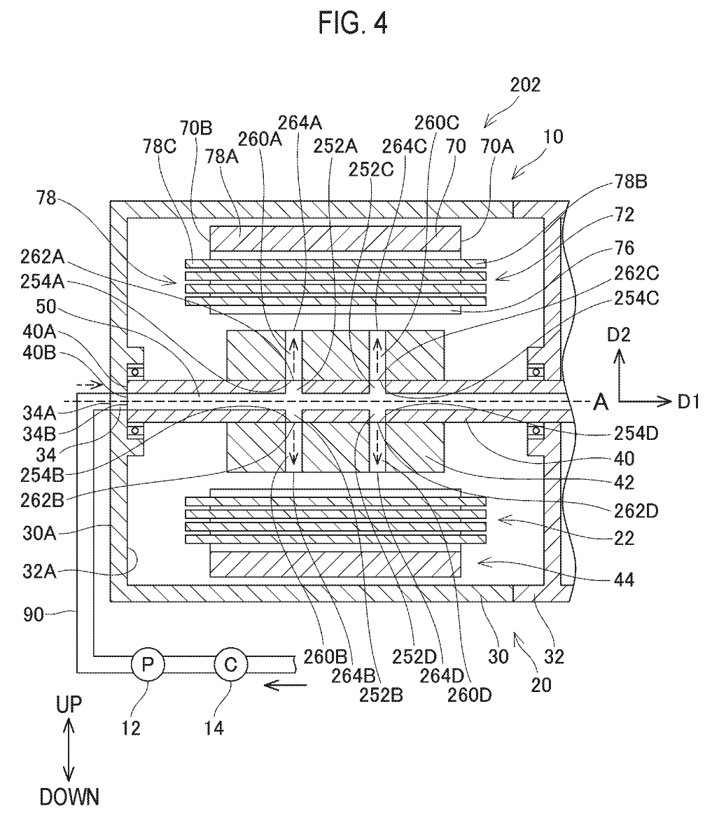

A drive device 202 of a second embodiment will be described with reference to FIG. 4. In the drive device 202 of the second embodiment, the shaft 240 and the rotor 242 have configurations different from the shaft 40 and the rotor 42 of the first embodiment. In the following, the same reference numerals will be used for the configurations common to the embodiments, and the description thereof will be omitted.

As shown in FIG. 4, the shaft 240 includes the first shaft flow path 50 and a plurality of second shaft flow paths 252A to 252D. The plurality of second shaft flow paths 252A to 252D branch from the first shaft flow path 50. Each of the second shaft flow paths 252A to 252D extends from the first shaft flow path 50 to third shaft openings 254A to 254D located on the outer peripheral surface of the shaft 240 in the radial direction D2. In the axial direction D1, the plurality of second shaft flow paths 252A, 252B are located on the axial direction other side of the central portion of the stator 44. The plurality of second shaft flow paths 252A, 252B are arranged at equal intervals in the circumferential direction D3. In the axial direction D1, the plurality of second shaft flow paths 252C, 252D are located on the axial direction one side of the central portion of the stator 44. The plurality of second shaft flow paths 252C, 252D are arranged at equal intervals in the circumferential direction D3.

The rotor 242 includes a plurality of rotor flow paths 260A to 260D. The plurality of rotor flow paths 260A to 260D extend from first rotor openings 262A to 262D located on the inner peripheral surface of the rotor 242 to second rotor openings 264A to 264D located on the outer peripheral surface of the rotor 242 in the radial direction D2. The plurality of rotor flow paths 260A, 260B are arranged at equal intervals in the circumferential direction D3. In the axial direction D1, the positions of the plurality of rotor flow paths 260A, 260B are the same as the positions of the plurality of second shaft flow paths 252A, 252B. Each of the rotor flow paths 260A, 260B communicates with the second shaft flow paths 252A, 252B. The plurality of rotor flow paths 260C, 260D are arranged at equal intervals in the circumferential direction D3. In the axial direction D1, the positions of the plurality of rotor flow paths 260C, 260D are the same as the positions of the plurality of second shaft flow paths 252C, 252D. Each of the rotor flow paths 260C, 260D communicates with the second shaft flow paths 252C, 252D.

With the above-described configuration, various parts of the stator 44 can be cooled in the axial direction D1 and the radial direction D2.

### Third Embodiment

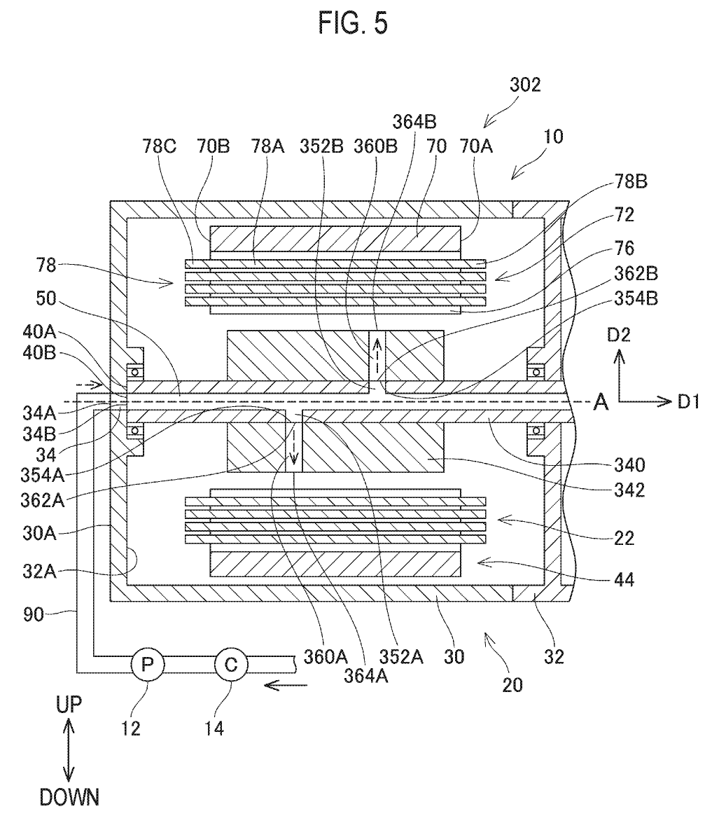

A drive device 302 of a third embodiment will be described with reference to FIG. 5. In the drive device 302 of the third embodiment, the shaft 340 and the rotor 342 have configurations different from the shaft 40 and the rotor 42 of the first embodiment.

As shown in FIG. 5, the shaft 340 includes the first shaft flow path 50 and a plurality of second shaft flow paths 352A, 352B. The plurality of second shaft flow paths 352A, 352B branch from the first shaft flow path 50. Each of the second shaft flow paths 352A, 352B extends from the first shaft flow path 50 to third shaft openings 354A, 354B located on the outer peripheral surface of the shaft 340 in the radial direction D2. In the axial direction D1, the second shaft flow path 352A is located on the axial direction other side of the central portion of the stator 44. In the axial direction D1, the second shaft flow path 352B is located on the axial direction one side of the central portion of the stator 44. In the radial direction D2, the second shaft flow path 352B is located on a side opposite to the second shaft flow path 352A.

The rotor 342 includes a plurality of rotor flow paths 360A, 360B. The rotor flow paths 360A, 360B extend from first rotor openings 362A, 362B located on the inner peripheral surface of the rotor 342 to second rotor openings 364A, 364B located on the outer peripheral surface of the rotor 342 in the radial direction D2. In the axial direction D1, the positions of the rotor flow paths 360A, 360B are the same as the positions of the second shaft flow paths 352A, 352B. Each of the rotor flow paths 360A, 360B communicates with the second shaft flow paths 352A, 352B.

With the above-described configuration, various parts of the stator 44 can be cooled in the axial direction D1 and the radial direction D2.

### Fourth Embodiment

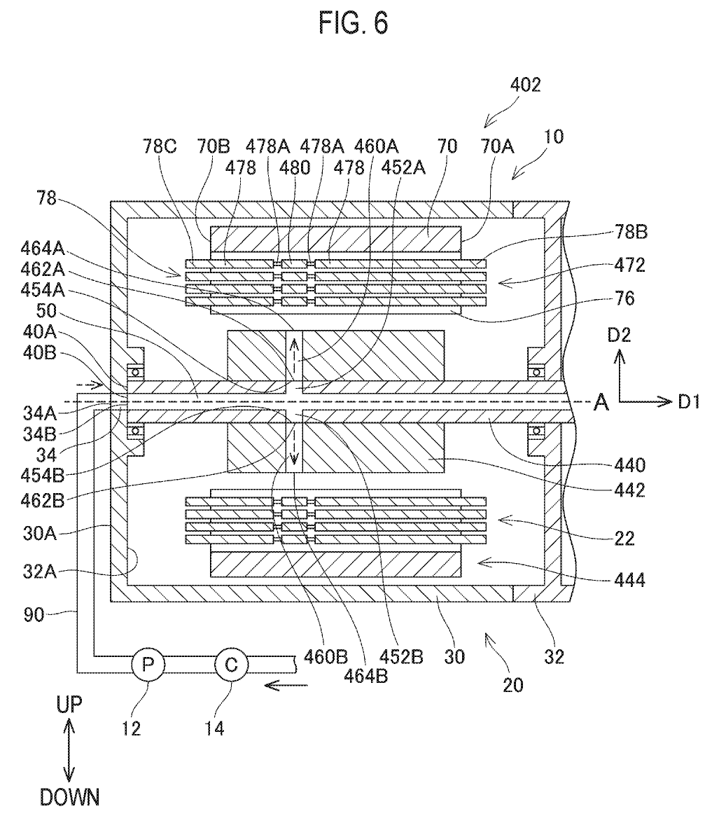

A drive device 402 of a fourth embodiment will be described with reference to FIG. 6. In the drive device 402 of the fourth embodiment, the shaft 440, the rotor 442, and the stator 444 have configurations different from the shaft 40, the rotor 42, and the stator 44 of the first embodiment.

As shown in FIG. 6, the shaft 440 includes the first shaft flow path 50 and a plurality of second shaft flow paths 452A, 452B. The plurality of second shaft flow paths 452A, 452B branch from the first shaft flow path 50. Each of the second shaft flow paths 452A, 452B extends from the first shaft flow path 50 to third shaft openings 454A, 454B located on the outer peripheral surface of the shaft 440 in the radial direction D2. The plurality of second shaft flow paths 452A, 452B are arranged at equal intervals in the circumferential direction D3.

The rotor 442 includes a plurality of rotor flow paths 460A, 460B. The rotor flow paths 460A, 460B extend from first rotor openings 462A, 462B located on the inner peripheral surface of the rotor 442 to second rotor openings 464A, 464B located on the outer peripheral surface of the rotor 442 in the radial direction D2. In the axial direction D1, the positions of the rotor flow paths 460A, 460B are the same as the positions of the second shaft flow paths 452A, 452B. Each of the rotor flow paths 460A, 460B communicates with the second shaft flow paths 452A, 452B.

The stator 444 includes the stator core 70 and a stator coil 472. The stator coil 472 is configured by coupling a plurality of segment coils 478. Each of the segment coils 478 is inserted into the slots 76 from the first end surface 70A or the second end surface 70B of the stator core 70. Each of the segment coils 478 is coupled to the other segment coil 478 by a connecting portion 480 in the slots 76. A fitting member having a cylindrical shape is provided in the connecting portion 480. Although it is an example, the fitting member is made of a metal such as copper. Each end part 478A of the pair of segment coils 478 is press-fitted into the fitting member from both sides. As a result, the pair of segment coils 478 are mechanically and electrically connected to each other at the connecting portion 480.

In the axial direction D1, the positions of the plurality of rotor flow paths 460A, 460B are substantially the same as the position of the connecting portion 480. Therefore, the oil discharged from the plurality of rotor flow paths 460A, 460B is supplied to the connecting portion 480.

As described above, the stator 444 includes the stator core 70 that includes the plurality of slots 76, and the stator coil 472 that includes the plurality of segment coils 478 and a plurality of connecting portions 480 that couple the end portions 478A of the two segment coils 478 in the slots 76. The rotor flow paths 460A, 460B supply the oil toward the connecting portion 480.

The connecting portion 480 of the plurality of segment coils 478 may easily generate heat. With the above-described configuration, the oil is supplied from the rotor flow paths 460A, 460B toward the connecting portion 480. Therefore, the connecting portion 480 can be cooled.

Although specific examples of the technology disclosed in the present specification have been described in detail above, these examples are merely illustrative and do not limit the scope of the claims. The technology described in the claims includes various modifications and changes of the specific examples exemplified above.

### First Modification

The motor unit may include a shaft including one second shaft flow path and a rotor including one rotor flow path.

### Second Modification

A plurality of rotor flow paths may communicate with one second shaft flow path. In addition, a plurality of second shaft flow paths may communicate with one rotor flow path.

### Third Modification

The second shaft flow path and the rotor flow path may be inclined with respect to the radial direction D2.

### Fourth Modification

In the fourth embodiment, positions of the plurality of connecting portions 480 in the axial direction D1 are the same. Positions of the plurality of connecting portions 480 in the axial direction D1 may be different from each other. In the present modification, the rotor 442 may include a plurality of rotor flow paths that supply the oil toward each of the plurality of connecting portions 480.

### Fifth Modification

In the fourth embodiment, the oil supplied from the plurality of rotor flow paths 460A, 460B may be directed to a portion different from the connecting portion 480.

### Sixth Modification

In each of the embodiments, the oil flows from the axial direction other side to the axial direction one side in the first shaft flow path 50. The oil may flow from the axial direction one side to the axial direction other side in the first shaft flow path 50.

In addition, the technical elements described in the present specification or the drawings exhibit technical usefulness alone or in various combinations and are not limited to the combinations described in the claims at the time of filing. Further, the technology exemplified in the present specification or the drawings can achieve a plurality of objectives at the same time, and achieving one of the objectives has technical usefulness.

What is claimed is:

1. A motor unit comprising:
a shaft extending along an axial direction;
a rotor fixed to an outer peripheral surface of the shaft; and
a stator disposed on a radially outer side of the rotor, wherein:
the shaft includes a first shaft flow path extending in the axial direction in the shaft, and one or more second shaft flow paths branched from the first shaft flow path and extending to an opening of the outer peripheral surface of the shaft;
the rotor includes one or more rotor flow paths extending from an opening of an inner peripheral surface of the rotor to an opening of an outer peripheral surface of the rotor, and configured to supply a refrigerant toward the stator; and
each of the one or more rotor flow paths is in communication with any one of the one or more second shaft flow paths.

2. The motor unit according to claim 1, wherein the one or more rotor flow paths include a flow path configured to supply the refrigerant toward a central portion of the stator in the axial direction.

3. The motor unit according to claim 1, wherein:
the stator includes:
a stator core having a plurality of slots; and
a stator coil including a plurality of segment coils and a plurality of connecting portions configured to connect end portions of two segment coils in the slots; and
the one or more rotor flow paths include a flow path configured to supply the refrigerant toward at least one of the connecting portions.

4. The motor unit according to claim 1, wherein:
the one or more second shaft flow paths include a plurality of second shaft flow paths;
the one or more rotor flow paths include a plurality of rotor flow paths; and
each of the rotor flow paths is in communication with any one of the second shaft flow paths.
